(19) United States
(12) Patent Application Publication
(10) Pub. No.: US 2025/0060163 A1
(43) Pub. Date: Feb. 20, 2025

(54) Geothermally Powered Pyrometallurgical Zinc Production

(71) Applicant: EnhancedGEO Holdings, LLC, St. Petersburg, FL (US)

(72) Inventors: Greg Lindberg, Thonotosassa, FL (US); Kimberly C. Conner, Wetumpka, AL (US)

(21) Appl. No.: 18/233,949

(22) Filed: Aug. 15, 2023

(51) Int. Cl. F27B 5/14; C22B 1/16; C22B 1/24; C22B 19/02; C22B 19/14; C22B 19/18; F24T 10/10

(52) U.S. Cl. CPC F27B 5/14; C22B 1/16; C22B 1/2406; C22B 19/02; C22B 19/14; C22B 19/18; F24T 10/10

(57) ABSTRACT

A geothermally powered zinc production subsystem includes a geothermal system with a wellbore extending from a surface into an underground magma reservoir. A hopper receives a sphalerite ore that is crushed and provided to a flotation tank. The flotation tank is heated by a heat transfer fluid heated by the geothermal system, and a product of the flotation tank is used to prepare zinc.

### TECHNICAL FIELD

The present disclosure relates generally to metal extraction and more particularly to zinc production powered by geothermal energy.

### BACKGROUND

Zinc is produced by refinement through energy intensive processes involving heat and mechanical energy. Considerable energy is expended to supply heat and power the equipment used to perform such production. Renewable energy sources, such as solar power and wind power, can be unreliable and have relatively low power densities, such that they may be insufficient to reliably power zinc production equipment. As such, production equipment typically relies on non-renewable fuels for power. There exists a need for improved zinc production processes.

### SUMMARY

This disclosure recognizes the previously unidentified and unmet need for a reliable renewable energy source for zinc production. This disclosure provides a solution to this unmet need in the form of a zinc production system that is powered at least partially by geothermal energy. A geothermal system harnesses heat from a geothermal resource with a sufficiently high temperature that can be used to power equipment used in zinc production. For example, steam may be obtained from a geothermal system and used to heat one or more reactor vessels to obtain zinc from an initial ore provided to the zinc production system. For example, heated fluid from a geothermal system may be used to heat a heat exchanger to maintain appropriate temperatures for reactions in a flotation tank. As another example, heated fluid may be used to heat a roaster to cause desired oxidation reactions. In some cases, one or more geothermally powered motors may be powered with steam from a geothermal system and used to support mechanical operations of the zinc production process, such as to crush and grind sphalerite. As another example, the same or a different geothermally powered motor may power a pump or conveyor that is used to move materials between different process equipment for zinc production. One or more turbines may be powered by the steam to provide electricity for any electronic components of the zinc production subsystems (e.g., electronic controllers, sensors, etc.).

In some embodiments, the geothermal system that powers the zinc production subsystems is a closed geothermal system that exchanges heat with an underground geothermal reservoir. The geothermal reservoir may be a magma reservoir. For example, an underground geothermal reservoir, such as a magma reservoir, may facilitate the generation of high-temperature, high-pressure steam, while avoiding problems and limitations associated with previous geothermal technology. The geothermal systems of this disclosure generally include a wellbore that extends from the surface into an underground thermal reservoir, such as a magma reservoir. A closed heat-transfer loop is employed in which a heat transfer fluid is pumped into the wellbore, heated via contact with the underground thermal reservoir, and returned to the surface to power a zinc production subsystem located within a sufficient proximity to the wellbore.

The geothermal system of this disclosure may harness a geothermal resource with sufficiently high amounts of energy from magmatic activity such that the geothermal resource does not degrade significantly over time. This disclosure illustrates improved systems and methods for capturing energy from magma reservoirs, dikes, sills, and other magmatic formations that are significantly higher in temperature than heat sources that are accessed using previous geothermal technologies, and that can contain an order of magnitude higher energy density than the geothermal fluids that power previous geothermal technologies. In some cases, the present disclosure can significantly decrease zinc production costs and/or reliance on non-renewable resources for zinc production subsystem operations. In some cases, the present disclosure may facilitate more efficient zinc production in regions where access to reliable power is currently unavailable or transport of non-renewable fuels is challenging. The systems and methods of the present disclosure may also or alternatively aid in decreasing carbon emissions.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a conventional geothermal system.

FIG. 3 is a diagram of an example improved geothermal system of this disclosure.

FIG. 4 is a diagram of an example system in which zinc production is powered by the improved geothermal system of FIG. 3.

FIG. 5 is a diagram of the example zinc oxide production system of FIG. 4, for extracting zinc-bearing materials from sphalerite to produce zinc oxide, in greater detail.

FIG. 6 is a diagram of the example zinc production system of FIG. 4, for extracting zinc from zinc oxide in a hydrometallurgical process, in greater detail.

FIG. 7 is a diagram of the example zinc production system of FIG. 4, for extracting zinc from zinc oxide in a pyrometallurgical process, in greater detail.

FIG. 8 is a flowchart of an example method for operating the systems of FIG. 4.

FIG. 9 is a diagram of an example system for performing thermal processes of FIGS. 3 and 4.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

The present disclosure includes unexpected observations, which include the following: (1) magma reservoirs can be located at relatively shallow depths of less than 2.5 km; (2) the top layer of a magma reservoir may have relatively few crystals with little or no mush zone; (3) rock near or around magma reservoirs may not be ductile and may support fractures; (4) a magma reservoir does not decline in thermal output over at least a two-year period; (5) eruptions at drill sites into magma reservoirs are unlikely (e.g., eruptions have not happened at African and Icelandic drill sites in over 10,000 years and it is believed a Kilauea, Hawaii drill site has never erupted); and (6) drilling into magma reservoirs can be reasonably safe.

As used herein, “magma” refers to extremely hot liquid and semi-liquid rock under the Earth's surface. Magma is formed from molten or semi-molten rock mixture found typically between 1 km to 10 km under the surface of the Earth. As used herein, “borehole” refers to a hole that is drilled to aid in the exploration and recovery of natural resources, including oil, gas, water, or heat from below the surface of the Earth. As used herein, a “wellbore” refers to a borehole either alone or in combination with one or more other components disposed within or in connection with the borehole in order to perform exploration and/or recovery processes. In some cases, the terms “wellbore” and “borehole” are used interchangeably. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes requiring heating or cooling.

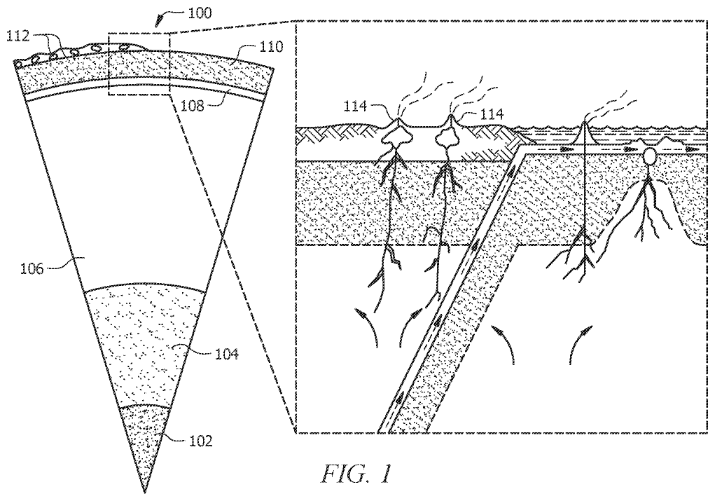

FIG. 1 is a partial cross-sectional diagram of the Earth depicting underground formations that can be tapped by geothermal systems of this disclosure (e.g., for generating geothermal power). The Earth is composed of an inner core 102, outer core 104, lower mantle 106, transition zone 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with the magma is desirable.

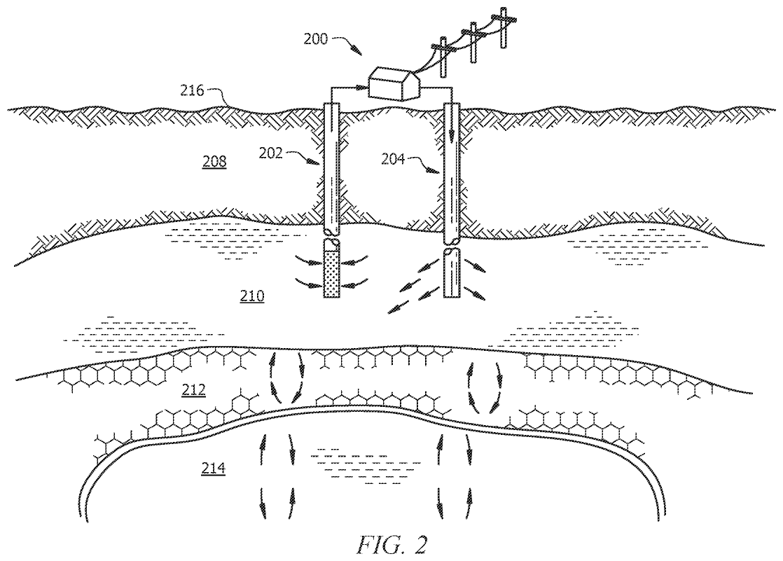

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the geothermal fluid layer 210 that serves as the source of geothermal water. The geothermal water is heated indirectly via heat transfer with intermediate layer 212, which is in turn heated by magma reservoir 214. Convective heat transfer (illustrated by the arrows indicating that hotter fluids rise to the upper portions of their respective layers before cooling and sinking, then rising again) may facilitate heat transfer between these layers. Geothermal water from the geothermal fluid layer 210 flows to the surface 216 and is used for geothermal power generation. The geothermal water (and possibly additional water or other fluids) is then injected back into the geothermal fluid layer 210 via an injection well 204.

The configuration of conventional geothermal system 200 of FIG. 2 suffers from drawbacks and disadvantages, as recognized by this disclosure. For example, because geothermal water is a polyphase fluid (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204.

### Example Improved Geothermal System

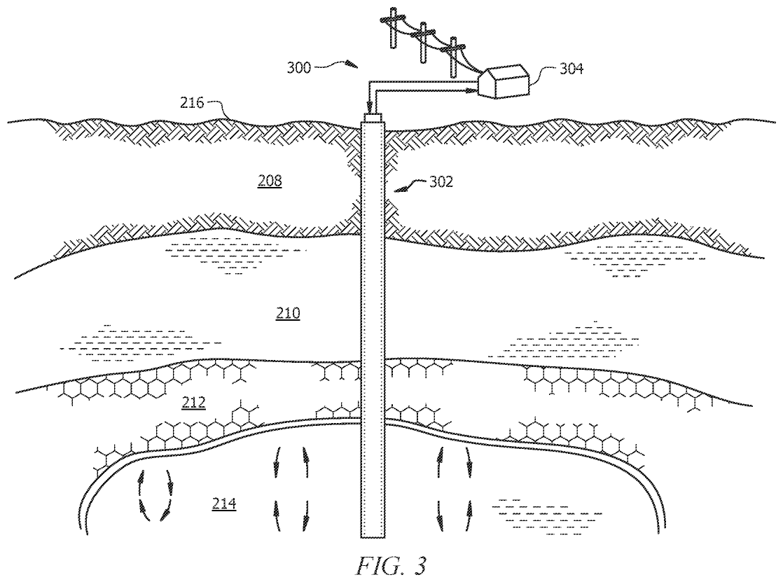

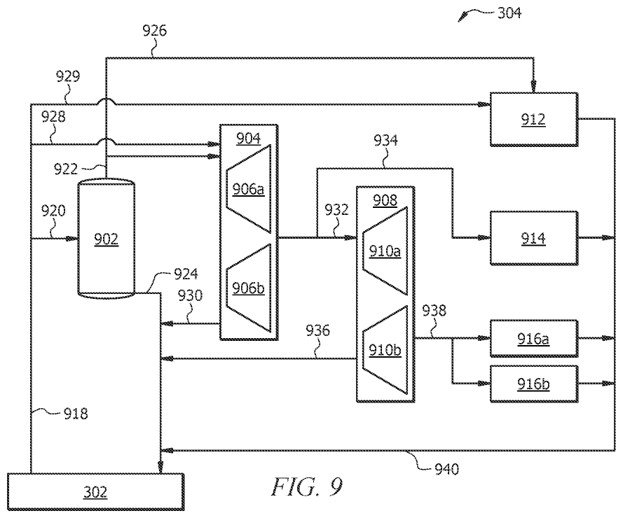

FIG. 3 illustrates an example magma-based geothermal system 300 of this disclosure. The magma-based geothermal system 300 includes a wellbore 302 that extends from the surface 216 at least partially into the magma reservoir 214. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 9 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation (and/or for more effectively driving other thermal processes). For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the magma-based geothermal system 300 has little or no risk of thermal shock-induced earthquakes, which might be attributed to the injection of cooler water into a hot geothermal zone, as is performed using the conventional geothermal system 200 of FIG. 2. The heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal Systems and Methods With an Underground Magma Chamber”; U.S. patent application Ser. No. 18/116,697, filed Mar. 2, 2023, and titled “Method and System for Preparing a Geothermal System with a Magma Chamber”; and U.S. Provisional Patent Application No. 63/444,703, filed Feb. 10, 2023, and titled “Geothermal Systems and Methods Using Energy from Underground Magma Reservoirs”, the entirety of each of which is hereby incorporated by reference.

### Geothermally Powered Zinc Production

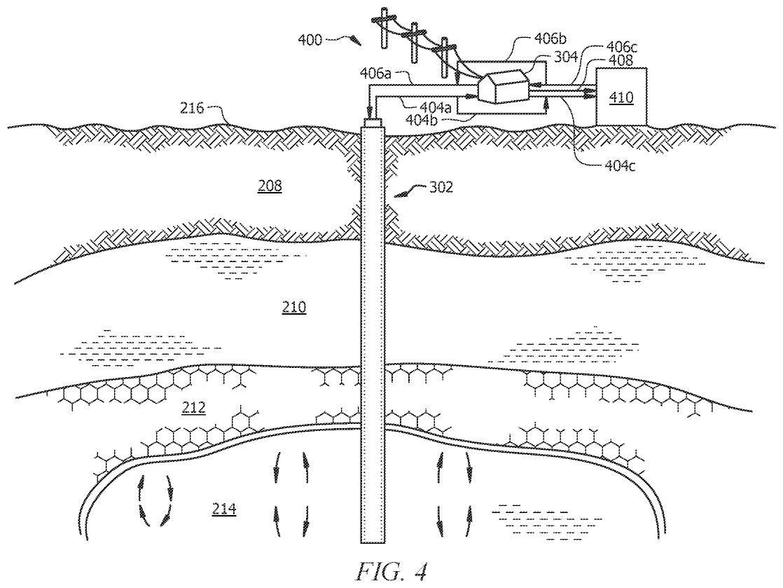

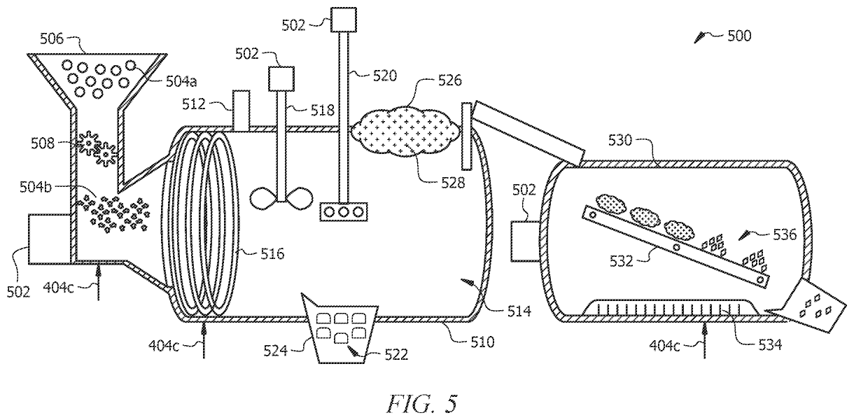

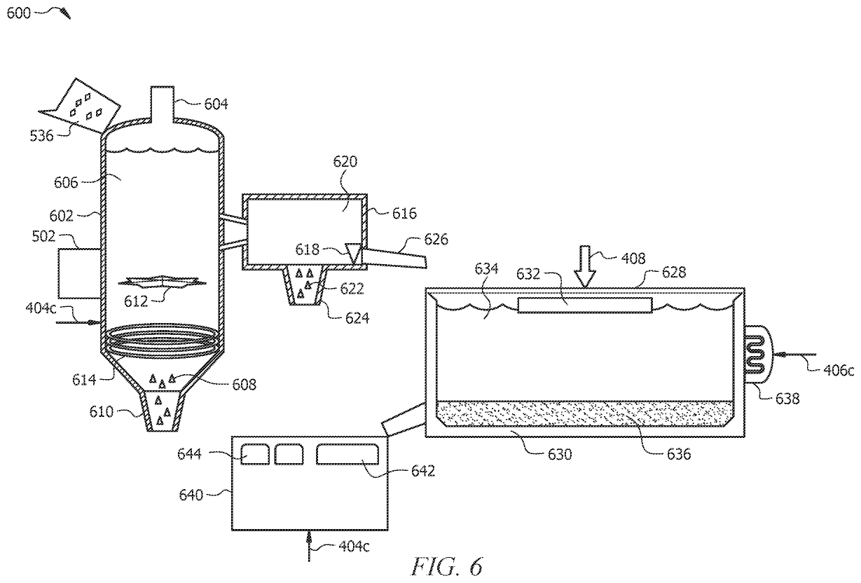

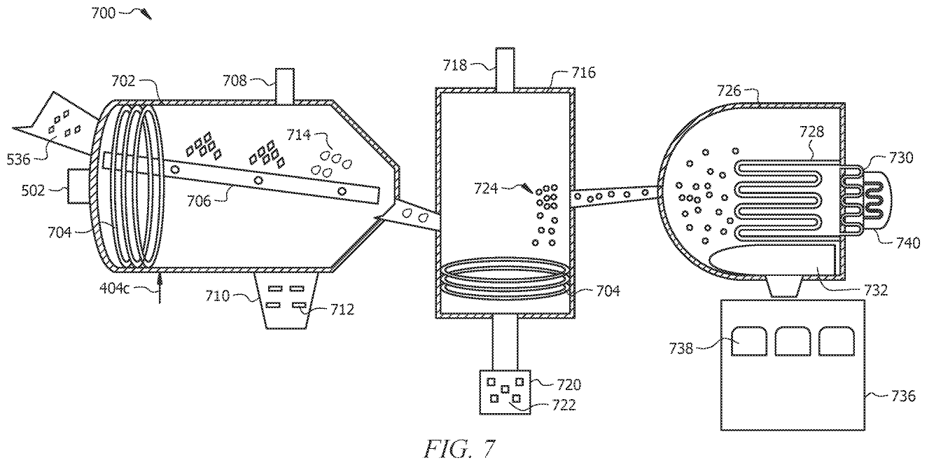

FIG. 4 illustrates an example combined geothermal and zinc production system 400 of this disclosure. The combined geothermal and zinc production system 400 includes all or a portion of the components of the magma-based geothermal system 300 described above with respect to FIG. 3 as well as geothermally powered zinc production system 410. The geothermally powered zinc production system 410 may include the geothermally powered zinc oxide system 500 for producing zinc oxide (see FIG. 5) along with a system for converting zinc oxide to zinc, such as the geothermally powered hydrometallurgical zinc system 600 of FIG. 6 or the geothermally powered pyrometallurgical zinc system 700 of FIG. 7. Examples of the geothermally powered zinc oxide system 500, geothermally powered hydrometallurgical zinc system 600, and geothermally powered pyrometallurgical zinc system 700 are described in greater detail below with respect to FIG. 5, FIG. 6, and FIG. 7. The combined geothermal and zinc production system 400 may include all or a portion of the thermal process system 304. In operation, heat transfer fluid is injected into the wellbore 302, which extends from the surface 216 into the magma reservoir 214 underground. The heated heat transfer fluid can be conveyed to the thermal process system 304 as heat transfer fluid 404a that can be used to drive processes, such as the generation of electricity by turbines 904 and 908 in FIG. 9. Heat transfer fluid 404a may be referred to in the alternative as a stream of heat transfer fluid 404a. Heat transfer fluid 404c, which can be formed from any remaining amount of heat transfer fluid 404a (e.g., steam) exiting from the thermal process system 304 and/or the wellbore bypass stream, i.e., heat transfer fluid 404b, is provided to the geothermally powered zinc production system 410. The electricity 408 may be used in addition to or in place of heat transfer fluid 404c for powering electrical and mechanical processes in the geothermally powered zinc production system 410.

As described in greater detail below with respect to FIGS. 5-7, a geothermally powered zinc oxide system uses the heat transfer fluid 404c to produce zinc oxide, and a geothermally powered hydrometallurgical zinc system (see FIG. 6) and/or a geothermally powered pyrometallurgical zinc system (see FIG. 7) use the heat transfer fluid 404c to process zinc oxide to produce zinc. For example, a motor of the geothermally powered zinc oxide system may be powered by the heat transfer fluid 404c, and the motor may provide motion to a hopper, crusher, conveyor, fluid pump(s), and/or the like of the geothermally powered zinc oxide system (see FIG. 5 and corresponding descriptions below). As another example, the geothermally powered zinc oxide system may include a fluid pump with a motor that is powered at least in part by the heat transfer fluid (e.g., steam) heated in the wellbore 302. As another example, the geothermally powered zinc oxide system may include a motor that aids in moving a mixer in a flotation tank and is powered by heat transfer fluid (e.g., steam) heated in the wellbore 302. In some cases, cooling may be desirable for certain processes. An absorption chiller may use heated fluid from the geothermal system to provide such cooling. In some cases, temperature adjustments or control may be achieved using heated fluid from the geothermal system and/or cooling from a geothermally powered absorption chiller. In this way, for example, smelting can be improved by operating at a temperature that facilitates more effective electrolytic reduction. More generally, reaction conditions can be adjusted to improve production of zinc using hot or cold fluid obtained via geothermal energy with limited or no use of other energy inputs.

Heat transfer fluid (e.g., condensed steam) that is cooled and/or or decreased in pressure after powering the geothermally powered zinc production system 410 may be returned to the wellbore 302 as heat transfer fluid 406a. For instance, as shown in the example of FIG. 4, a stream of return heat transfer fluid 406c may be provided back to the thermal process system 304, used to drive one or more reactions or processes, and then expelled as heat transfer fluid 406a for return to the wellbore 302. The heat transfer fluid 406a can also include a bypass stream of heat transfer fluid 406b, which can be formed from heat transfer fluid 406c, in whole or in part. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 is steam (or another heat transfer fluid at an elevated temperature and/or pressure). While the example of FIG. 4 includes the thermal process system 304 of FIG. 3, in some cases, the combined geothermal and zinc production system 400 may exclude all or a portion of the thermal process system 304. For example, the wellbore stream of heat transfer fluid 404a from the wellbore 302 may be provided directly to the geothermally powered zinc production system 410 (see wellbore bypass stream of heat transfer fluid 404b described above).

Heat transfer fluid in streams 404a-c and 406a-c may be any appropriate fluid for absorbing heat within the wellbore 302 and driving operations of the geothermally powered zinc production system 410 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600° F. and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the combined geothermal and zinc production system 400. As an example, the heat transfer fluid may be water. The water is supplied to the wellbore 302 as stream of heat transfer fluid 406a in the liquid phase and is transformed into steam within the wellbore 302. The steam is received as a stream of heat transfer fluid 404a and used to drive the geothermally powered zinc production system 410.

### Example Geothermally Powered Zinc Oxide Production System

FIG. 5 shows an example of the geothermally powered zinc oxide system 500 of FIG. 4 in greater detail. The configuration of FIG. 5 is provided as an example only. The geothermally powered zinc oxide system 500 may include more or fewer components, and the components may be arranged in different configurations to produce zinc oxide 536. The example geothermally powered zinc oxide system 500 includes a hopper 506, a crusher 508, a flotation tank 510, and a roaster 530. These main components and other components may be powered at least partially by geothermal energy from the heat transfer fluid 404c (e.g. steam), which obtained its heat from the magma reservoir 214 via the stream of heat transfer fluid 404a. This heat transfer fluid 404c may be used directly to heat components in geothermally powered zinc oxide system 500 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered zinc oxide system 500. The geothermally powered zinc oxide system 500 extracts zinc from zinc-bearing minerals to produce zinc oxide that is used to produce zinc in a geothermally powered zinc hydrometallurgical system 600 of FIG. 6, a geothermally powered zinc pyrometallurgical system 700 of FIG. 7, or another appropriate system.

During operation of the geothermally powered zinc oxide system 500, a sphalerite 504a (a zinc-bearing sulfide mineral) enters the hopper 506 and is crushed and ground by the crusher 508. Zinc may be extracted from any number of zinc-bearing ores, such as marmalite (ZnFeS), calamine (ZnCO₃), or willemite (2ZnO·SiO₂). Sphalerite (ZnS) is a commonly mined zinc-bearing mineral and is used as an example ore in this disclosure. The geothermally powered zinc oxide system 500 and the methods described below may be used to process any zinc-bearing mineral to extract zinc. The hopper 506 can be any appropriate type of open funnel that receives sphalerite. It may contain a screen or a feeder. A geothermally powered motor 502 coupled to the crusher 508 powers the crusher 508. The geothermally powered motor 502 can be coupled to system components, such as the crusher 508, using conventional means, e.g., mechanical, electrical, pneumatic, etc., which are omitted for the sake of simplicity. The crusher 508 can be any appropriate type of machine that operates by rolling, impacting, milling, vibrating, and/or grinding. For example, the crusher may be a jaw crusher, impact crusher, or ball mill. The geothermally powered motor 502 may be geothermally powered directly by the heat transfer fluid 404c that is heated by the magma reservoir 214. An example of geothermally powered motor is described in U.S. Provisional Patent Application No. 63/448,929, filed Feb. 28, 2023, and titled “Drilling Equipment Powered by Geothermal Energy,” the entirety of which is incorporated herein by reference.

A crushed and ground sphalerite 504b enters the flotation tank 510 to be processed into a slurry 514. The flotation tank 510 is any vessel that can accommodate inputs for reagents and can be capable of maintaining a desired temperature to facilitate the extraction of zinc materials from the crushed and ground sphalerite 504b. The flotation tank 510 combines the crushed and ground sphalerite 504b with flotation reagents 512 and water. The flotation reagents 512 and water can be introduced into the flotation tank 510 via conventional means and are omitted for the sake of simplicity. The flotation reagents 512 are any chemical capable of selectively separating hydrophobic from hydrophilic materials in the slurry 514, exploiting the differences in wettabilities of different materials. Examples of the flotation reagents 512 are frothers (permit and stabilize bubble formation), promoters or collectors (decrease the wettability of the desired mineral), modifiers (increase wettability of the undesired mineral), depressors (render floatable minerals unfloatable), or activators (render unfloatable minerals, previously rendered so by depressors, floatable). Flocculants or coagulants may also be used to cause the desired or undesired mineral to clump.

Example activators for sulfide minerals are sulfates with metal ions that form a more stable metal sulfide than sphalerite (ZnS). Sulfates of cuprous, cupric, mercurous, mercuric, silver, lead, cadmium, and antimony can form a stable sulfide that resists dissolution in the slurry 514, permitting it to more readily undergo the collection process. In the example of FIG. 5, copper sulfate (CuSO₄) is one of the flotation reagents 512 (activator) used in the reaction ZnS(s)+CuSO₄(aq)→CuS(s)+ZnSO₄(aq) to form a thin film of copper sulfide on the sphalerite surface which allows for stable attachment of a xanthate rendering the sphalerite particle hydrophobic and floatable. Example collectors for sulfide minerals are sulfhydryl collectors, such as xanthates and dithiophosphates. Xanthates are most used for sphalerite, due to high selectivity for sulfide minerals, as they chemically react with the sulfide surfaces and do not have any affinity for non-sulfide byproducts 522. In the example of FIG. 5, sodium ethyl xanthate (CH₃CH₂OCS₂Na) is one of the flotation reagents 512 (collector) used. The OCSS⁻ group irreversibly attaches to the sulfide mineral surface, rendering the sulfide hydrophobic. Additional flotation reagents 512 may be added to the slurry 514 to adjust for varying mineral constituents present in the crushed and ground sphalerite 504b (e.g., iron, lead, copper), and may be added simultaneously or step-wise. Additional flotation tanks 510 may be used to float different target metals (e.g., iron, lead, copper) and remove different byproducts using different flotation reagents 512. For example, a flotation tank 510 may be used to float lead prior to floating zinc, in which appropriate flotation reagents 512 are used to target lead. Such a flotation tank 510 may be used before or after or simultaneously to one or more additional flotation tanks to extract zinc and other metals that may be present in the ore. Zinc oxide ores may be processed in a similar system using flotation reagents appropriate for targeting oxides (e.g., attaching the carboxyl group of oleic acid, used as a collector, to the surface of ZnO).

The flotation tank 510 is maintained at an elevated temperature appropriate for the mineral content of the crushed and ground sphalerite 504b (e.g., about 45° C.) and a pH (e.g., in a range from 5 to 11.5). The elevated temperature of the flotation tank 510 can be provided by a heat exchanger 516, which can be heated by heat transfer fluid 404c. The heat exchanger 516 is depicted as disposed within the flotation tank 510 in FIG. 5 to provide heat directly to the slurry 514, but in other embodiments the heat exchanger 516 can be arranged to heat the walls of the flotation tank 510 which can then heat the slurry 514. Heat exchange between the heat exchanger 516 and the slurry 514 and/or flotation tank 510 induces a reaction to form a froth 526 containing zinc sulfide 528. Examples of the heat exchanger 516 include shell-and-tube or tube-in-tube type heat exchangers. A mixer 518 and an air intake 520 may be used to enhance agitation of the slurry 514. The mixer 518 is any machine capable of agitating the slurry 514 contained by the flotation tank 510. In the example of FIG. 5, a geothermally powered motor 502 rotates the mixer 518. The mixer 518 may be beaters, paddles, propellers, hydrofoils, or turbines, as examples. The air intake 520 is any machine capable of introducing air into the slurry 514 contained by the flotation tank 510. In the example of FIG. 5, a geothermally powered motor 502 powers the air intake 520. The air intake 520 may be aerators, bubblers, or spargers, as examples. During flotation in the flotation tank 510, byproducts 522 (e.g., iron) may be removed from the slurry 514 where at least a portion may be transferred to a waste collection reservoir 524.

The froth 526 containing zinc sulfide 528 is then heated in the roaster 530 to convert it to zinc oxide 536. The roaster 530 is any vessel that can be heated and can receive and handle the zinc sulfide 528. The roaster 530 is heated by a furnace 534 which receives heat transfer fluid 404c. A conveyor 532 conveys the zinc sulfide 528 through the roaster 530 during the roasting process across the length of the chamber and is driven by a geothermally powered motor 502. The conveyor 532 can convey the zinc sulfide 528 by a rolling motion, sliding motion, or radial motion, for example, along a belt or roller system, or moved in a fluidized bed. The roaster 530 can be a multiple-hearth roaster, a suspension roaster, or a fluidized-bed roaster, and heats the zinc sulfide 528 to temperatures up to 1000° C. Roasting causes an oxidation reaction 2ZnS+3O₂→2ZnO+2SO₂. Zinc oxide 536 is a product of this process.

### Example Geothermally Powered Hydrometallurmical Zinc Production System

The zinc oxide 536 may be processed by either hydrometallurgy (FIG. 6) or by pyrometallurgy (FIG. 7) to produce zinc. FIG. 6 shows an example of the geothermally powered zinc hydrometallurgical system 600. The configuration of FIG. 6 is provided as an example only. The geothermally powered zinc hydrometallurgical system 600 may include more or fewer components, and the components may be arranged in different configurations to produce zinc product 644. The example geothermally powered zinc hydrometallurgical system 600 includes a leach tank 602, a purification tank 616, an electrolytic smelter 628, and a foundry 640. These main components and other components may be powered at least partially by geothermal energy from the heat transfer fluid 404c (e.g., steam), which obtained its heat from the magma reservoir 214 via the stream of heat transfer fluid 404a. This heat transfer fluid 404c may be used directly to heat components in the geothermally powered zinc hydrometallurgical system 600 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered zinc hydrometallurgical system 600.

The zinc oxide 536 is received by the leach tank 602 where it may be further processed by leaching. The leach tank 602 is any vessel that can extract Zn²¹ into a leach product 606 (a zinc-containing solution) and separate it from leach residue 608 (insoluble byproducts). The leach product 606 is agitated by a mixer 612. The mixer 612 is any machine capable of agitating the leach product 606 contained by the leach tank 602. In the example of FIG. 6, a geothermally powered motor 502 rotates the mixer 612. The mixer 612 may be beaters, paddles, propellers, hydrofoils, or turbines, as examples. The temperature of the leach tank 602 is maintained at a slightly elevated temperature. Heat can be provided by a heat exchanger 614, which can be heated by heat transfer fluid 404c. The heat exchanger 614 is depicted as disposed within the leach tank 602 in FIG. 6 to provide heat directly to the leach product 606, but in other embodiments the heat exchanger 614 can be arranged to heat the walls of the leach tank 602 which can then heat the leach product 606. Examples of the heat exchanger 614 include shell-and-tube or tube-in-tube type heat exchangers. An acid 604 is used to perform the extraction of zinc. Diluted sulfuric acid is an example acid. The acid 604 causes a reaction ZnO+H₂SO₄→ZnSO₄+H₂O. The zinc sulfate solution 620 is the product. Leach residue 608 settles to the bottom of the leach tank 602 where it may be collected in a leach residue reservoir 610.

The zinc sulfate solution 620 may be purified in a purification tank 616. The purification tank 616 is any vessel that can remove impurities 622 (e.g., silica) that were not previously removed from the leach product 606. A filter 618 may be used to separate the impurities 622 from the zinc sulfate solution 620. The filter 618 is any machine capable of removing at least one component from the zinc sulfate solution 620. Filtration may be performed by chemical and/or mechanical means. In the example of FIG. 6, the filter 618 is driven by a geothermally powered motor 502. The filter 618 can be a drum filter or vacuum filter, as examples. The impurities 622 may be provided to an impurities reservoir 624. Removal of the impurities 622 produces a purified zinc sulfate solution 626.

The purified zinc sulfate solution 626 can be electrolytically reduced via the electrowinning process or another appropriate process in an electrolytic smelter 628. Electrolytic reduction is driven by a current between a cathode 630 which lines the smelting bath 634 and an anode 632. Example materials that may be used for the cathode 630 are aluminum sheets and for the anode 632 is lead containing 0.5 to 1.0% silver. The purified zinc sulfate solution 626 acts as an electrolyte and is fed into the smelting bath 634 using conventional means that are omitted for the sake of simplicity. Electrolysis causes a zinc coating 636 to deposit on the cathode 630 and oxygen to form at the anode 632 by a reaction 2ZnSO₄+2H₂O→2H₂SO₄+2Zn+O₂. This example reaction for electrolytic reduction is exothermic. As such, the electrolytic smelter 628 may be cooled (e.g., using an absorption chiller 638 powered by geothermal energy, as described above) to maintain an appropriate reaction temperature without the temperature in the electrolytic smelter 628 becoming elevated beyond a maximum level and/or to maintain the temperature in the electrolytic smelter 628 at a target temperature or within a target temperature range. The absorption chiller 638 is positioned within or proximate to the electrolytic smelter 628. Electrolysis requires a high energy demand. This disclosure provides a solution to this problem by facilitating the operation of the electrolytic smelter 628 using geothermal energy. For example, the current used for electrolysis may be supplied by electricity 408 derived from the conversion of heat in the heat transfer fluid 404c by turbines (e.g., turbines 904, 908 of FIG. 9), and the smelting bath 634 is heated by a heat transfer fluid 404c to help improve electrolytic efficiency.

The zinc coating 636 is removed every 24 to 48 hours using conventional means that are omitted for the sake of simplicity. The zinc coating 636 may be melted in a foundry 640 to produce molten zinc 642. The foundry 640 can be any vessel capable of receiving and containing the molten zinc 642, cooling the molten zinc 642, and forming it into masses of various shapes and sizes. The foundry 640 may be heated by the heat transfer fluid 404c in a similar manner that the leach tank 602 is heated by the heat transfer fluid 404c. The final zinc product 644 may be cast into any desired shape, for example, ingots, slabs, billets, and t-bars.

### Example Geothermally Powered Pyrometallurmical Zinc Production System

The zinc oxide 536 may be alternatively processed by pyrometallurgy (FIG. 7). FIG. 7 shows an example of the geothermally powered zinc pyrometallurgical system 700. The configuration of FIG. 7 is provided as an example only. The geothermally powered zinc pyrometallurgical system 700 may include more or fewer components, and the components may be arranged in different configurations in order to produce zinc product 738. Other examples are the Blast furnace process (i.e., Imperial smelting process), the New Jersey continuous vertical retort, and the Belgian-type horizontal retort processes. These processes may be adapted to use some of the components and configurations shown in FIG. 7 and similarly produce zinc product 738 by pyrometallurgy. The example geothermally powered zinc pyrometallurgical system 700 includes a sinter 702, a retort furnace 716, a zinc condenser 726, and a collecting trough 736. These main components and other components may be powered at least partially by geothermal energy from the heat transfer fluid 404c (e.g., steam), which obtained its heat from the magma reservoir 214 via the stream of heat transfer fluid 404a. This heat transfer fluid 404c may be used directly to heat components in the geothermally powered zinc pyrometallurgical system 700 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered zinc pyrometallurgical system 700.

The zinc oxide 536 is received by the sinter 702 where it may be further processed by sintering. The sinter 702 is any vessel that can be heated and can receive and handle the zinc oxide 536. Some impurities 712 (e.g., lead, cadmium, halides) remain after roasting which must be removed to increase purity of the zinc oxide 536 in preparation for treatment in a retort furnace 716. The temperature of the sinter 702 is maintained at an elevated temperature (e.g., 1200-1400° C.). Heat can be provided by a heat exchanger 704, which can be heated by heat transfer fluid 404c. The heat exchanger 704 is depicted as disposed within the sinter 702 in FIG. 7 to provide heat directly to the zinc oxide 536, but in other embodiments the heat exchanger 704 can be arranged to heat the walls of the sinter 702 which can then heat the zinc oxide 536. Examples of the heat exchanger 704 include shell-and-tube or tube-in-tube type heat exchangers. A conveyor 706 conveys the zinc oxide 536 through the sinter 702 during the sintering process across the length of the vessel and is driven by a geothermally powered motor 502. The conveyor 706 can convey the zinc oxide 536 by a rolling motion, sliding motion, or radial motion, for example, along a belt or roller system, or moved in a fluidized bed. The sinter 702 can be a rotary kiln, gas suspension calciner, fluidized bed calciner, or fluid flash calciner. Combustion gases 708 are injected into the sinter 702 to cause at least a portion of the impurities 712 remaining from the roasting to be removed by their reaction with oxygen in the combustion gases. An example combustion gas is O₂. Example reactions are 2ZnS+3O₂→2ZnO+2SO₂, ZnS+2O₂→ZnSO₄, and 2ZnSO₄→2ZnO+2SO₂+O₂. Similar reactions may occur with other metal oxides present as impurities (e.g., lead, cadmium). Product sinter 714 is the product. The product sinter 714 is a ZnO agglomerate (i.e., lumps of zinc-bearing material) which is suitable for treatment in the retort furnace 716. The impurities 712 are transferred to an impurities reservoir 710.

The product sinter 714 is heated in the retort furnace 716 to convert it to a zinc vapor 724. The retort furnace 716 is any vessel that can be heated and can receive and handle the product sinter 714. In the example of FIG. 7, a retort furnace 716 is used, but any reduction furnace may be used. The retort furnace 716 is heated by a heat exchanger 704, which receives heat transfer fluid 404c. The retort furnace 716 heats the product sinter 714 to a temperature of 1000° C. to 1500° C. Coke 718 is added to supply carbon to cause the carbothermic reaction ZnO+C→Zn+CO. Zinc vapor 724 is a product of this process. Slag 722 (i.e., the byproduct remaining after zinc extraction) is transferred to a discharge basin 720.

The zinc vapor 724 is treated in a zinc condenser 726. The zinc condenser 726 is maintained at a lower temperature than the retort furnace 716 by using cooling tubes 728 to receive heat from the zinc vapor 724. The cooling tubes 728 are depicted as disposed within the zinc condenser in FIG. 7 to provide cooling fluid directly to the zinc vapor 724, but in other embodiments the cooling tubes 728 can be arranged to cool the walls of the zinc condenser 726 which can then cool the zinc vapor 724. The cooling fluid is moved through the cooling tubes 728 to receive heat and is moved through a circulating cooler 730 to transfer heat out of the cooling fluid. The circulating cooler 730 may be cooled (e.g., using an absorption chiller 740 powered by geothermal energy, as described above) to maintain an appropriate zinc phase change temperature, such that the temperature in the zinc condenser 726 does not increase above a maximum level and/or the temperature in the zinc condenser 726 is maintained at or near a target temperature or within a target temperature range. The cooling causes a reaction Zn(vapor)→Zn(liquid) (907° C. boiling point at 1 atm). Zinc vapor 724 may be condensed by alternative systems. Examples of alternative systems are bubbling the zinc vapor 724 through a molten zinc bath or by bringing the zinc vapor 724 in contact with a cooling metal (e.g., liquid lead) then allowing the zinc and the cooling metal to cool and separate into two distinct liquid layers which can be separately tapped. In these alternative systems, cooling may be achieved in a similar way as described in FIG. 7. The zinc liquid 732 is the product. The zinc liquid 732 settles to the bottom of the zinc condenser 726 where it may be collected in a collecting trough 736. The zinc liquid 732 is allowed to cool into a zinc product 738 (i.e., a solid zinc material) of desired shape and form.

### Example Method of Geothermally Powered Zinc Production

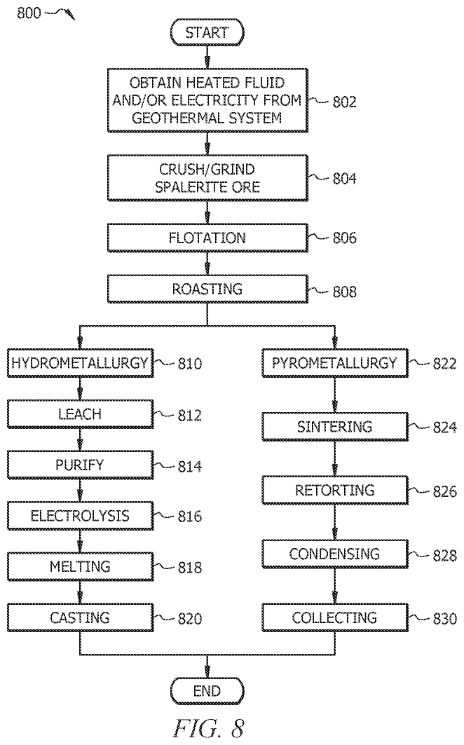

FIG. 8 shows an example method 800 of operating the geothermally powered zinc oxide system 500 in FIG. 5. The method 800 may begin at 802. At step 802, the heated heat transfer fluid 404c and/or electricity 408 are received from the geothermal system, as described above with respect to FIGS. 1-4. At step 804, sphalerite is crushed and/or ground using a geothermally powered motor. At step 806, a slurry is produced by combining and mixing the crushed and/or ground sphalerite with flotation reagents and air bubbles, and heating with the heat transfer fluid 404c to produce a froth containing zinc sulfide in the slurry. At step 808, the froth is roasted with the heat transfer fluid 404c to cause at least a portion of the zinc sulfide to become zinc oxide. At step 810, the zinc oxide is transferred to a hydrometallurgical process. At step 812, the zinc oxide is leached by combining and mixing with an acid and heating with the heat transfer fluid 404c to produce a leach product. At step 814, the leach product is purified by using a filter powered by using the heat transfer fluid 404c to produce a zinc sulfate solution. At step 816, an electrolytic smelter reduces the zinc sulfate solution causing a zinc coating to deposit on a cathode and oxygen to form at an anode. Step 816 may be driven by current between the anode and the cathode described in FIG. 6, the current being generated by electricity 408 from the geothermally powered turbines configured to use the heat transfer fluid 404c heated by the geothermal system. At step 818, the zinc coating is heated by the heat transfer fluid 404c to produce molten zinc. At step 820, the molten zinc is cast in a foundry.

An alternative process to the hydrometallurgical process of steps 812-820 is the pyrometallurgical process of steps 824-830. At step 822, the zinc oxide is transferred to a pyrometallurgical process. At Step 824, the zinc oxide is sintered by combining and mixing with a combustion gas and heating with the heat transfer fluid 404c to produce a product sinter. At step 826, the product sinter is heated in a retort furnace using the heat transfer fluid 404c to produce a zinc vapor. At step 828, zinc condenser cools the zinc vapor causing a zinc liquid to form. Step 828 may be performed using a circulating cooler circulating cooling fluid described with respect to FIG. 7 above. At step 830, the zinc liquid is collected in a collecting trough and allowed to cool to produce a zinc product.

Modifications, omissions, or additions may be made to method 800 depicted in FIG. 8. Method 800 may include more, fewer, or other steps. For example, at least certain steps may be performed in parallel or in any suitable order. While at times discussed as geothermally powered zinc oxide system 500 performing steps, any suitable component of the geothermally powered zinc oxide system 500 or other components of a geothermal system may perform or may be used to perform one or more steps of the method 800.

### Example Thermal Process System

FIG. 9 shows a schematic diagram of an example thermal process system 304 of FIGS. 3 and 4. The thermal process system 304 includes a condenser 902, a first turbine set 904, a second turbine set 908, a high-temperature/pressure thermochemical process 912, a medium-temperature/pressure thermochemical process 914, and one or more lower temperature/pressure processes 916a,b. The thermal process system 304 may include more or fewer components than are shown in the example of FIG. 9. For example, a thermal process system 304 used for power generation alone may omit the high-temperature/pressure thermochemical process 912, medium-temperature/pressure thermochemical process 914, and lower temperature/pressure processes 916a,b. Similarly, a thermal process system 304 that is not used for power generation may omit the turbine sets 904, 908. As a further example, if heat transfer fluid is known to be received only in the gas phase, the condenser 902 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 9, the condenser 902 is connected to the wellbore 302 that extends between a surface and the underground magma reservoir. The condenser 902 separates a gas-phase heat transfer fluid (e.g., steam) from liquid-phase heat transfer fluid (e.g., condensate formed from the gas-phase heat transfer fluid). The condenser 902 may be a steam separator. A stream 920 received from the wellbore 302 may be provided to the condenser 902. In some cases, all of stream 918 is provided in stream 920. In other cases, a fraction or none of stream 918 is provided to the condenser 902. Instead, all or a portion of the stream 918 may be provided as stream 928 which may be provided to the first turbine set 904 and/or to a high-pressure thermal process 912 in stream 929. The thermal process 912 may be a thermochemical reaction requiring high temperatures and/or pressures (e.g., temperatures of between 500° F. and 2,000° F. and/or pressures of between 1,000 psig and 4,500 psig), such as the geothermally powered zinc oxide system 500. One or more valves (not shown for conciseness) may be used to control the direction of stream 920 to the condenser 902, first turbine set 904, and/or thermal process 912. A gas-phase stream 922 of heat transfer fluid from the condenser 902 may be sent to the first turbine set 904 and/or the thermal process 912 via stream 926. A liquid-phase stream 924 of heat transfer fluid from the condenser 902 may be provided back to the wellbore 302.

The first turbine set 904 includes one or more turbines 906a,b. In the example of FIG. 9, the first turbine set includes two turbines 906a,b. However, the first turbine set 904 can include any appropriate number of turbines for a given need. The turbines 906a,b may be any known or yet to be developed turbine for electricity generation. The first turbine set 904 is connected to the condenser 902 and is configured to generate electricity from the gas-phase heat transfer fluid (e.g., steam) received from the condenser 902 (gas-phase stream 922). A condensate stream 930 exits the first turbine set 904. The condensate stream 930 may be provided back to the wellbore 302.

If the heat transfer fluid is at a sufficiently high temperature, as may be uniquely and more efficiently possible using the wellbore 302, a stream 932 of gas-phase heat transfer fluid may exit the first turbine set 904. Stream 932 may be provided to a second turbine set 908 to generate additional electricity. The turbines 910a,b of the second turbine set 908 may be the same as or similar to turbines 906a,b, described above.

All or a portion of stream 932 may be sent as gas-phase stream 934 to a thermal process 914. Process 914 is generally a process requiring gas-phase heat transfer fluid at or near the conditions of the heat transfer fluid exiting the first turbine set 904. For example, the thermal process 914 may include one or more thermochemical processes requiring steam or another heat transfer fluid at or near the temperature and pressure of stream 932 (e.g., temperatures of between 250° F. and 1,500° F. and/or pressures of between 500 psig and 2,000 psig). The second turbine set 908 may be referred to as “low pressure turbines” because they operate at a lower pressure than the first turbine set 904. Condensate from the second turbine set 908 is provided back to the wellbore 302 via stream 936.

An effluent stream 938 from the second turbine set 908 may be provided to one or more thermal process 916a,b. Thermal processes 916a,b generally require less thermal energy than thermal processes 912 and 914, described above (e.g., processes 916a,b may be performed temperatures of between 220° F. and 700° F. and/or pressures of between 15 psig and 120 psig). As an example, processes 916a,b may include water distillation processes, heat-driven chilling processes, space heating processes, agriculture processes, aquaculture processes, and/or the like. For instance, an example heat-driven chiller process 916a may be implemented using one or more heat driven chillers. Heat driven chillers can be implemented, for example, in data centers, crypto-currency mining facilities, or other locations in which undesirable amounts of heat are generated. Heat driven chillers, also conventionally referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 940 from all processes 912, 914, 916a,b, may be provided back to the wellbore 302.

The geothermally powered zinc oxide system 500 can achieve high temperatures via heat transfer fluids in contact with a magma chamber or in contact with heat transfer fluids heated by a magma chamber for operations that require heating. This ability to obtain high heat transfer allows deployment of alternative methods of production that have been deemed too energy intensive to practically implement. For example, the hydrometallurgical process (FIG. 6) of extracting zinc from sphalerite is considered the industry standard—only one modern US zinc refinery continues to use the pyrometallurgical process (FIG. 7)—due to its lower energy requirement compared to the process of sintering. However, sintering permits zinc extraction from a wide variety of zinc-bearing materials which may be more easily accessible or readily available which would otherwise be deemed too low quality to process and become waste, resulting in economic loss and environmental impacts.

The geothermally powered systems of this disclosure may reduce waste in several ways. In addition to the advantages of the alternative equipment and/or methods described above, waste may further be reduced by the ability to process waste byproducts of the zinc production system into useful secondary raw materials. Waste byproducts of metal refining often sit idle and contribute to pollution of local environments. The storage, disposal, and recycling of these byproducts, such as electric arc furnace dust, slag, and refractories is costly. The efficient and clean supply of energy from geothermal resources can power the processing of such wastes. Additionally, waste can be reduced by reducing carbon emissions from the electrolysis conventionally used during smelting. This process requires large amounts of electrical power. An estimated power consumption of 2.8 kWh per kg of zinc produced presents challenges to the industry in terms of energy availability and cost and provides profit and environmental motivation to utilizing geothermal energy as presented in this disclosure. As described in this disclosure, geothermal energy can power zinc production systems to produce less waste and less pollution (e.g., without using coal-fired processes or with a significant decrease in the use of such processes). As such, this disclosure may facilitate zinc production with a decreased environmental impact and decreased use of costly materials.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

### Additional Embodiments

Embodiment 1. A geothermally powered zinc production system, comprising:
a geothermal system comprising a wellbore extending from a surface into an underground magma reservoir, the wellbore configured to heat a heat transfer fluid via heat transfer with the underground magma reservoir, thereby forming heated heat transfer fluid;
a hopper comprising a vessel configured to receive a sphalerite ore and direct the received sphalerite ore through a crusher;
the crusher configured to crush at least a portion of the sphalerite ore directed therethrough, thereby forming crushed sphalerite ore;
a flotation tank configured to:
   receive at least a portion of the crushed sphalerite ore and flotation reagents;
   suspend the received crushed sphalerite ore and received flotation reagents in a slurry; and
   heat the slurry via heat transfer with the heated heat transfer fluid, thereby forming a froth comprising zinc sulfide; and
a roaster configured to:
   receive at least a portion of the froth produced by the flotation tank; and
   heat the received froth via heat transfer with the heated heat transfer fluid, thereby causing the zinc sulfide to convert to zinc oxide, wherein the system optionally includes any one or more of the following limitations:
wherein the flotation tank comprises:
one or more heat exchangers configured to heat the slurry via heat transfer with the heated heat transfer fluid;
a mixer configured to agitate the slurry;
an air intake configured to inject air into the slurry; and
a waste collection reservoir positioned within or proximate to the flotation tank, configured to receive at least a portion of a byproduct;
wherein the roaster comprises:
one or more heat exchangers configured to heat the froth received from the flotation tank via heat transfer with the heated heat transfer fluid; and
one or more conveyors configured to transport the froth through the roaster;
one or more geothermally powered motors configured to use the heated heat transfer fluid to perform mechanical operations, wherein the one or more geothermally powered motors are configured to perform one or more of:
moving the sphalerite ore through the hopper;
rotating the crushers;
rotating a mixer in the flotation tank; and
driving a conveyor to move the zinc sulfide through the roaster; and
one or more heat exchangers configured to circulate the heated heat transfer fluid, wherein the one or more heat exchangers are configured to perform one or more of the following:
heating the flotation tank; and
heating the roaster.

Embodiment 2. A method, comprising:
heating, using a geothermal system comprising a wellbore extending from a surface into an underground magma reservoir, a heat transfer fluid via heat transfer with the underground magma reservoir, thereby forming heated heat transfer fluid;
directing, using a hopper, a sphalerite ore through a crusher;
crushing, using the crusher, at least a portion of the sphalerite ore directed therethrough, thereby forming crushed sphalerite ore;
receiving, by a flotation tank, at least a portion of the crushed sphalerite ore and flotation reagents;
suspending the received crushed sphalerite ore and received flotation reagents in a slurry held in the flotation tank;
heating the slurry in the flotation tank via heat transfer with the heated heat transfer fluid, thereby forming a froth comprising zinc sulfide;
receiving, by a roaster, at least a portion of the froth produced by the flotation tank; and
heating, in the roaster, the received froth via heat transfer with the heated heat transfer fluid, thereby causing the zinc sulfide to convert to zinc oxide, wherein the method optionally includes any one or more of the following limitations:
wherein producing the froth further comprises:
heating the slurry with one or more heat exchangers via heat transfer with the heated heat transfer fluid;
agitating the slurry;
injecting air into the slurry; and receiving at least a portion of a byproduct in a waste collection reservoir;
wherein heating the froth in the roaster further comprises:
heating the froth with one or more heat exchangers via heat transfer with the heated heat transfer fluid; and
transporting the froth via one or more conveyors through the roaster;
using one or more motors powered by the heated heat transfer fluid, wherein the one or more geothermally powered motors are configured to perform one or more of:
moving the sphalerite ore through the hopper;
rotating the crushers;
rotating a mixer in the flotation tank; and
driving a conveyor to move the zinc sulfide through the roaster; and
causing one or more heat exchangers to use the heated heat transfer fluid to heat a fluid wherein the heated fluid supplies heat for one or more of:
heating the flotation tank; and
heating the roaster.

Embodiment 3. A geothermally powered zinc production system comprising: a geothermal system comprising a wellbore extending from a surface into an underground magma reservoir, the wellbore configured to heat a heat transfer fluid via heat transfer with the underground magma reservoir, thereby forming heated heat transfer fluid;
a leach tank configured to:
   receive zinc oxide;
   receive an acid; and
   heat the received zinc oxide and the received acid via heat transfer with the heated heat transfer fluid, thereby producing a leach product and a leach residue;
a purification tank configured to:
   receive at least a portion of the leach product produced by the leach tank; and
   remove impurities from the received portion of the leach product, thereby producing a zinc sulfate solution;
an electrolytic smelter configured to:
   receive at least a portion of the zinc sulfate solution produced by the purification tank; and
   conduct electrical current through the received zinc sulfate solution via electricity generated using the heated heat transfer fluid, thereby causing a zinc coating to form; and
a foundry configured to:
   receive at least a portion of the zinc coating produced by the electrolytic smelter;
   heat the received zinc coating via heat transfer with the heated heat transfer fluid, thereby causing the zinc coating to melt and become molten zinc; and
   cast the molten zinc to form a zinc product, wherein the system optionally includes any one or more of the following limitations:
wherein the leach tank comprises:
one or more heat exchangers configured to heat the leach product via heat transfer with the heated heat transfer fluid;
a mixer configured to agitate the leach product, thereby causing separation of the leach residue and the leach product; and a leach residue reservoir positioned within or proximate to the leach tank, configured to receive at least a portion of the leach residue produced in the leach tank;
wherein the purification tank comprises:
a filter configured to separate the impurities from the leach product; and
an impurities reservoir positioned within or proximate to the purification tank, configured to receive at least a portion of the impurities;
wherein the electrolytic smelter comprises:
one or more circulating coolers configured to cool the zinc sulfate solution via heat transfer with a cooled heat transfer fluid; and
a cathode and an anode configured to conduct electricity through the zinc sulfate solution, thereby forming the zinc coating;
further comprising:
a hopper comprising a vessel configured to receive a sphalerite ore and direct the received sphalerite ore through a crusher;
the crusher configured to crush at least a portion of the sphalerite ore directed therethrough, thereby forming crushed sphalerite ore;
a flotation tank configured to:
   receive at least a portion of a crushed sphalerite ore and flotation reagents;
   suspend the received crushed sphalerite ore and received flotation reagents in a slurry; and
   heat the slurry via heat transfer with the heated heat transfer fluid, thereby forming a froth comprising zinc sulfide; and
a roaster configured to:
   receive at least a portion of the froth produced by the flotation tank; and
   heat the received froth via heat transfer with the heated heat transfer fluid, thereby producing the zinc oxide;
one or more geothermally powered motors configured to use the heated heat transfer fluid to perform mechanical operations of the geothermally powered zinc production system, wherein the one or more geothermally powered motors are configured to rotate a mixer in the leach tank;
one or more turbines configured to use the heated heat transfer fluid to generate electricity, wherein the generated electricity provides an electrical current between a cathode and an anode in the electrolytic smelter; and
one or more heat exchangers configured to circulate the heated heat transfer fluid to perform operations of the geothermally powered zinc production system, wherein the one or more heat exchangers are configured to perform one or more of:
   heating the leach tank;
   heating the electrolytic smelter; and
   heating the foundry.

Embodiment 4. A method, comprising:
heating, using a geothermal system comprising a wellbore extending from a surface into an underground magma reservoir, a heat transfer fluid via heat transfer with the underground magma reservoir, thereby forming heated heat transfer fluid;
receiving, by a leach tank, zinc oxide;
receiving, by the leach tank, an acid;
heating the received zinc oxide and the received acid via heat transfer with the heated heat transfer fluid, thereby producing a leach product and a leach residue;
receiving, by a purification tank, at least a portion of the leach product produced by the leach tank;
removing, by a purification tank, impurities from the received portion of the leach product, thereby producing a zinc sulfate solution;
receiving, by an electrolytic smelter, at least a portion of the zinc sulfate solution;
conducting electrical current through the received zinc sulfate solution via electricity generated using the heated heat transfer fluid, thereby causing a zinc coating to form;
receiving, by a foundry, at least a portion of the zinc coating produced by the electrolytic smelter;
heating, by the foundry, the received zinc coating via heat transfer with the heated heat transfer fluid, thereby causing the zinc coating to melt and become molten zinc; and
casting the molten zinc to form a zinc product, wherein the method optionally includes any one or more of the following limitations:
wherein producing the leach product further comprises:
heating, by one or more heat exchangers, the leach product via heat transfer with the heated heat transfer fluid;
agitating, by a mixer, the leach product, thereby causing separation of the leach residue and the leach product; and directing at least a portion of the leach residue produced in the leach tank to a leach residue reservoir;
wherein producing the zinc sulfate solution further comprises:
separating, by a filter, impurities from the leach product; and
directing the impurities to an impurities reservoir;
wherein producing the zinc coating comprises:
cooling, by one or more circulating coolers, the zinc sulfate solution via heat transfer with a cooled heat transfer fluid; and
conducting, by a cathode and an anode, electricity in the zinc sulfate solution, thereby forming the zinc coating;
further comprising:
heating, using a geothermal system comprising a wellbore extending from a surface into an underground magma reservoir, a heat transfer fluid via heat transfer with the underground magma reservoir, thereby forming heated heat transfer fluid;
directing, using a hopper, a sphalerite ore through a crusher;
crushing, using the crusher, at least a portion of the sphalerite ore directed therethrough, thereby forming crushed sphalerite ore;
receiving, by a flotation tank, at least a portion of the crushed sphalerite ore and flotation reagents;
suspending the received crushed sphalerite ore and received flotation reagents in a slurry held in the flotation tank;
heating the slurry in the flotation tank via heat transfer with the heated heat transfer fluid, thereby forming a froth comprising zinc sulfide;
receiving, by a roaster, at least a portion of the froth produced by the flotation tank; and
heating, in the roaster, the received froth via heat transfer with the heated heat transfer fluid, thereby causing the zinc sulfide to convert to zinc oxide;
using one or more motors powered by the heated heat transfer fluid, wherein the one or more geothermally powered motors are configured to perform one or more of rotating a mixer in the leach tank;
causing one or more turbines to use the heated heat transfer fluid to generate electricity, wherein the generated electricity provides an electrical current between a cathode and an anode in the electrolytic smelter; and
causing one or more heat exchangers to use the heated heat transfer fluid to heat a fluid wherein the heated fluid supplies heat for one or more of:
heating the leach tank;
heating the electrolytic smelter; and heating the foundry.

Embodiment 5. A geothermally powered zinc production system comprising:
a geothermal system comprising a wellbore extending from a surface into an underground magma reservoir, the wellbore configured to heat a heat transfer fluid via heat transfer with the underground magma reservoir, thereby forming heated heat transfer fluid;
a sinter configured to:
   receive a zinc oxide;
   receive combustion gases; and
   heat the received zinc oxide and the received combustion gases via heat transfer with the heated heat transfer fluid, thereby igniting the combustion gases and exposing the received zinc oxide to the ignited combustion gases and producing a product sinter;
a retort furnace configured to:
   receive at least a portion of the product sinter produced by the sinter;
   receive coke; and
   heat the received product sinter and the received coke via heat transfer with the heated heat transfer fluid, thereby producing a zinc vapor;
a zinc condenser configured to:
   receive at least a portion of the zinc vapor produced by the retort furnace;
   receive a cooling fluid; and
   transfer heat from the zinc vapor to the cooling fluid, thereby producing a zinc liquid; and
a collecting trough configured to:
   receive at least a portion of the zinc liquid produced by the zinc condenser; and
   cast the received zinc liquid to produce a zinc product, wherein the system optionally includes any one or more of the following limitations:
wherein the sinter comprises:
one or more conveyors configured to transport the zinc oxide through the sinter;
one or more heat exchangers configured to heat the zinc oxide via heat transfer with the heated heat transfer fluid, thereby producing the product sinter and impurities; and
an impurities reservoir positioned within or proximate to the sinter, configured to receive at least a portion of the impurities;
wherein the retort furnace comprises:
one or more heat exchangers configured to heat the product sinter via heat transfer with the heated heat transfer fluid, thereby producing the zinc vapor and a slag; and
a discharge basin configured to receive the slag;
wherein the zinc condenser comprises:
cooling tubes positioned within or proximate to the zinc condenser, the cooling tubes configured to circulate the cooling fluid therethrough such that the cooling fluid receives heat from the zinc vapor, and a zinc liquid and a heated cooling fluid are produced; and
a circulating cooler configured to receive the heated cooling fluid produced by the cooling tubes and cools the heated cooling fluid;
further comprising:
a hopper comprising a vessel configured to receive a sphalerite ore and direct the received sphalerite ore through a crusher;
the crusher configured to crush at least a portion of the sphalerite ore directed therethrough, thereby forming crushed sphalerite ore;
a flotation tank configured to:
   receive at least a portion of a crushed sphalerite ore and flotation reagents;
   suspend the received crushed sphalerite ore and received flotation reagents in a slurry; and
   heat the slurry via heat transfer with the heated heat transfer fluid, thereby forming a froth comprising zinc sulfide; and a roaster configured to:
receive at least a portion of the froth produced by the flotation tank; and heat the received froth via heat transfer with the heated heat transfer fluid, thereby producing the zinc oxide;
one or more geothermally powered motors configured to use the heated heat transfer fluid to perform mechanical operations, wherein the one or more geothermally powered motors are configured to perform one or more of driving a conveyor to move the zinc oxide through the sinter;
one or more heat exchangers configured to circulate the heated heat transfer fluid, wherein the one or more heat exchangers are configured to perform one or more of the following: heating the sinter; and heating the retort furnace.

Embodiment 6. A method, comprising:
heating, using a geothermal system comprising a wellbore extending from a surface into an underground magma reservoir, a heat transfer fluid via heat transfer with the underground magma reservoir, thereby forming heated heat transfer fluid;
receiving, by a sinter, zinc oxide;
receiving, by the sinter, combustion gases;
heating the received zinc oxide and the received combustion gases via heat transfer with the heated heat transfer fluid, thereby igniting the combustion gases and exposing the received zinc oxide to the ignited combustion gases and producing a product sinter;
receiving, by a retort furnace, at least a portion of the product sinter produced by the sinter;
receiving, by the retort furnace, coke;
heating the received product sinter and the received coke via heat transfer with the heated heat transfer fluid, thereby producing a zinc vapor;
receiving, by a zinc condenser, at least a portion of the zinc vapor produced by the retort furnace;
receiving, by the zinc condenser, a cooling fluid;
transferring heat from the received zinc vapor to the cooling fluid, thereby producing a zinc liquid;
receiving, by a collecting trough, at least a portion of the zinc liquid produced by the zinc condenser; and
casting the received zinc liquid to produce a zinc product, wherein the method optionally includes any one or more of the following limitations:
wherein producing the product sinter comprises:
transporting, by one or more conveyors, the zinc oxide through the sinter;
heating, by one or more heat exchangers coupled to the sinter, the zinc oxide via heat transfer with the heated heat transfer fluid, thereby producing the product sinter and impurities; and
directing the impurities to an impurities reservoir;
wherein producing zinc vapor comprises:
heating, by one or more heat exchangers, the product sinter via heat transfer with the heated heat transfer fluid, thereby producing the zinc vapor and a slag; and directing the slag to a discharge basin;
wherein producing zinc liquid comprises:
circulating, by cooling tubes, a cooling fluid;
transferring heat from the zinc vapor to the cooling fluid, thereby producing a zinc liquid and a heated cooling fluid; and
cooling, by a circulating cooler, the heated cooling fluid to produce a cooling fluid;
further comprising:
heating, using a geothermal system comprising a wellbore extending from a surface into an underground magma reservoir, a heat transfer fluid via heat transfer with the underground magma reservoir, thereby forming heated heat transfer fluid;
directing, using a hopper, a sphalerite ore through a crusher;
crushing, using the crusher, at least a portion of the sphalerite ore directed therethrough, thereby forming crushed sphalerite ore;
receiving, by a flotation tank, at least a portion of the crushed sphalerite ore and flotation reagents;
suspending the received crushed sphalerite ore and received flotation reagents in a slurry held in the flotation tank;
heating the slurry in the flotation tank via heat transfer with the heated heat transfer fluid, thereby forming a froth comprising zinc sulfide;
receiving, by a roaster, at least a portion of the froth produced by the flotation tank; and
heating, in the roaster, the received froth via heat transfer with the heated heat transfer fluid, thereby causing the zinc sulfide to convert to zinc oxide;
using one or more motors powered by the heated heat transfer fluid to perform one or more of driving a conveyor to move the zinc oxide through the sinter;
causing one or more heat exchangers to use the heated heat transfer fluid to heat a fluid wherein the heated fluid supplies heat for one or more of:
heating the sinter; and
heating the retort furnace.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

What is claimed is:

1. A geothermally powered zinc production system, comprising:
a geothermal system comprising a wellbore extending from a surface into an underground magma reservoir, the wellbore configured to heat a heat transfer fluid via heat transfer with the underground magma reservoir, thereby forming heated heat transfer fluid;
a sinter configured to:
receive a zinc oxide;
receive combustion gases; and
heat the received zinc oxide and the received combustion gases via heat transfer with the heated heat transfer fluid, thereby igniting the combustion gases and exposing the received zinc oxide to the ignited combustion gases and producing a product sinter;
a retort furnace configured to:
receive at least a portion of the product sinter produced by the sinter;
receive coke; and
heat the received product sinter and the received coke via heat transfer with the heated heat transfer fluid, thereby producing a zinc vapor;
a zinc condenser configured to:
receive at least a portion of the zinc vapor produced by the retort furnace;
receive a cooling fluid; and
transfer heat from the zinc vapor to the cooling fluid, thereby producing a zinc liquid; and
a collecting trough configured to:
receive at least a portion of the zinc liquid produced by the zinc condenser; and
cast the received zinc liquid to produce a zinc product.

2. The geothermally powered zinc production system of claim 1, wherein the sinter comprises:
one or more conveyors configured to transport the zinc oxide through the sinter;
one or more heat exchangers configured to heat the zinc oxide via heat transfer with the heated heat transfer fluid, thereby producing the product sinter and impurities; and
an impurities reservoir positioned within or proximate to the sinter, configured to receive at least a portion of the impurities.

3. The geothermally powered zinc production system of claim 1, wherein the retort furnace comprises:
one or more heat exchangers configured to heat the product sinter via heat transfer with the heated heat transfer fluid, thereby producing the zinc vapor and a slag; and
a discharge basin configured to receive the slag.

4. The geothermally powered zinc production system of claim 1, wherein the zinc condenser comprises:
cooling tubes positioned within or proximate to the zinc condenser, the cooling tubes configured to circulate the cooling fluid therethrough such that the cooling fluid receives heat from the zinc vapor, and a zinc liquid and a heated cooling fluid are produced; and
a circulating cooler configured to receive the heated cooling fluid produced by the cooling tubes and cools the heated cooling fluid.

5. The geothermally powered zinc production system of claim 1, further comprising:
a hopper comprising a vessel configured to receive a sphalerite ore and direct the received sphalerite ore through a crusher;
the crusher configured to crush at least a portion of the sphalerite ore directed therethrough, thereby forming crushed sphalerite ore;
a flotation tank configured to:
receive at least a portion of a crushed sphalerite ore and flotation reagents;
suspend the received crushed sphalerite ore and received flotation reagents in a slurry; and
heat the slurry via heat transfer with the heated heat transfer fluid, thereby forming a froth comprising zinc sulfide; and
a roaster configured to:
receive at least a portion of the froth produced by the flotation tank; and
heat the received froth via heat transfer with the heated heat transfer fluid, thereby producing the zinc oxide.

6. The geothermally powered zinc production system of claim 1, further comprising one or more geothermally powered motors configured to use the heated heat transfer fluid to perform mechanical operations, wherein the one or more geothermally powered motors are configured to perform one or more of driving a conveyor to move the zinc oxide through the sinter.

7. The geothermally powered zinc production system of claim 1, further comprising one or more heat exchangers configured to circulate the heated heat transfer fluid, wherein the one or more heat exchangers are configured to perform one or more of:
heating the sinter; and
heating the retort furnace.

8. A method, comprising:
heating, using a geothermal system comprising a wellbore extending from a surface into an underground magma reservoir, a heat transfer fluid via heat transfer with the underground magma reservoir, thereby forming heated heat transfer fluid;
receiving, by a sinter, zinc oxide;
receiving, by the sinter, combustion gases;
heating the received zinc oxide and the received combustion gases via heat transfer with the heated heat transfer fluid, thereby igniting the combustion gases and exposing the received zinc oxide to the ignited combustion gases and producing a product sinter;
receiving, by a retort furnace, at least a portion of the product sinter produced by the sinter;
receiving, by the retort furnace, coke;
heating the received product sinter and the received coke via heat transfer with the heated heat transfer fluid, thereby producing a zinc vapor;
receiving, by a zinc condenser, at least a portion of the zinc vapor produced by the retort furnace;
receiving, by the zinc condenser, a cooling fluid;
transferring heat from the received zinc vapor to the cooling fluid, thereby producing a zinc liquid;
receiving, by a collecting trough, at least a portion of the zinc liquid produced by the zinc condenser; and
casting the received zinc liquid to produce a zinc product.

9. The method of claim 8, wherein producing the product sinter comprises:
transporting, by one or more conveyors, the zinc oxide through the sinter;
heating, by one or more heat exchangers coupled to the sinter, the zinc oxide via heat transfer with the heated heat transfer fluid, thereby producing the product sinter and impurities; and
directing the impurities to an impurities reservoir.

10. The method of claim 8, wherein producing zinc vapor comprises:
heating, by one or more heat exchangers, the product sinter via heat transfer with the heated heat transfer fluid, thereby producing the zinc vapor and a slag; and
directing the slag to a discharge basin.

11. The method of claim 8, wherein producing zinc liquid comprises:
circulating, by cooling tubes, a cooling fluid;
transferring heat from the zinc vapor to the cooling fluid, thereby producing a zinc liquid and a heated cooling fluid; and
cooling, by a circulating cooler, the heated cooling fluid to produce a cooling fluid.

12. The method of claim 8, further comprising:
heating, using a geothermal system comprising a wellbore extending from a surface into an underground magma reservoir, a heat transfer fluid via heat transfer with the underground magma reservoir, thereby forming heated heat transfer fluid;
directing, using a hopper, a sphalerite ore through a crusher;
crushing, using the crusher, at least a portion of the sphalerite ore directed therethrough, thereby forming crushed sphalerite ore;
receiving, by a flotation tank, at least a portion of the crushed sphalerite ore and flotation reagents;
suspending the received crushed sphalerite ore and received flotation reagents in a slurry held in the flotation tank;
heating the slurry in the flotation tank via heat transfer with the heated heat transfer fluid, thereby forming a froth comprising zinc sulfide;
receiving, by a roaster, at least a portion of the froth produced by the flotation tank; and
heating, in the roaster, the received froth via heat transfer with the heated heat transfer fluid, thereby causing the zinc sulfide to convert to a zinc oxide.

13. The method of claim 8, further comprising using one or more motors powered by the heated heat transfer fluid to perform one or more of driving a conveyor to move the zinc oxide through the sinter.

14. The method of claim 8, further comprising causing one or more heat exchangers to use the heated heat transfer fluid to heat a fluid wherein the heated fluid supplies heat for one or more of:
heating the sinter; and
heating the retort furnace.
